(19) United States
(12) Patent Application Publication
(10) Pub. No.: US 2009/0172382 A1
(43) Pub. Date: Jul. 2, 2009

(54) Multi-function computer system

(76) Inventor: Te-Chuan Hsieh, Kaohsiung City (TW)

Correspondence Address: Joe McKinney Muncy, PO Box 1364, Fairfax, VA, 22038-1364, US

(21) Appl. No.: 12/005,356

(22) Filed: Dec. 27, 2007

(51) Int. Cl. G06F 15/177

(52) U.S. Cl. 713/2

(57) ABSTRACT

A multi-function computer system includes a host apparatus, a display and a boot mode switching unit. The display is electrically connected to the host apparatus. The boot mode switching unit electrically connected to the host apparatus may be switched between a first mode and a second mode. In the first mode, the boot mode switching unit controls the host apparatus to boot into a first operation environment. In the second mode, the boot mode switching unit controls the host apparatus to boot into a second operation environment different from the first operation environment.

### BACKGROUND OF THE INVENTION

1. Field of Invention

The invention relates in general to a multi-function computer system, and more particularly to a multi-function computer system capable of selectively entering multiple operation environments.

2. Related Art

A conventional notebook computer or desktop computer has the powerful processor and various peripheral devices, and thus can execute various application programs to process various works, including editing, graphing, music playing, film playing, photograph displaying, television program watching and game playing. However, the current computer has many peripheral devices and daemon programs (e.g., messengers). Each time the computer is booted up, the drivers for the peripheral devices and the daemon programs occupy a lot of space in the memory. Thus, when the other specific program (e.g., a game) is loaded into the memory, the memory allocation may have errors and the specific program cannot be successfully executed. At this time, the user may release the daemon programs from the memory and the operation system temporarily so that he or she can play the game normally. However, such an operation tends to make the user feel very complicated.

In addition, when the user, who is not familiar with the computer operation, wants to watch the television program or play the media file of the optical disk using the computer, he or she has to boot up the computer. After all drivers and daemon programs have been loaded into the operation system and the memory, the user has to execute the specific software program to play the media file of the optical disk or the television program. However, because the user is not familiar with the computer operation, he or she may be afraid to damage the data in the computer and may thus feel that the operation is complicated and time-consuming.

Thus, it is an important subject of the invention to provide a multi-function computer system, which is dedicated to executing specific software programs.

### SUMMARY OF THE INVENTION

It is therefore an object of the invention to provide a multi-function computer system, which is controlled by hardware switches to make a user selectively execute some specific software programs to perform specific works.

The invention achieves the above-identified object by providing a multi-function computer system including a host apparatus, a display and a boot mode switching unit. The display is electrically connected to the host apparatus. The boot mode switching unit is electrically connected to the host apparatus and may be switched between a first mode and a second mode. In the first mode, the boot mode switching unit controls the host apparatus to boot into a first operation environment. In the second mode, the boot mode switching unit controls the host apparatus to boot into a second operation environment different from the first operation environment.

Further scope of the applicability of the present invention will become apparent from the detailed description given hereinafter. However, it should be understood that the detailed description and specific example, while indicating preferred embodiment of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus is not limitative of the present invention, and wherein:

FIG. 1 is a block diagram showing a multi-function computer system according to a preferred embodiment of the invention.

### DETAILED DESCRIPTION OF THE INVENTION

The present invention will be apparent from the following detailed description, which proceeds with reference to the accompanying drawing, wherein the same references relate to the same elements.

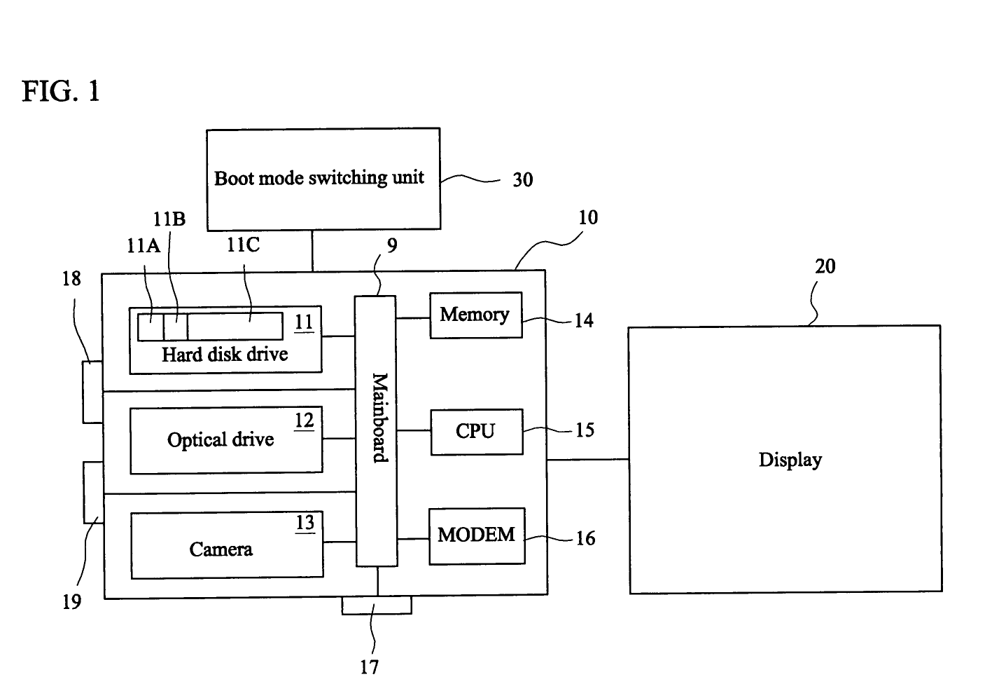

FIG. 1 is a block diagram showing a multi-function computer system according to a preferred embodiment of the invention. Referring to FIG. 1, the multi-function computer system of this embodiment includes a host apparatus 10, a display 20 and a boot mode switching unit 30. In this embodiment, the multi-function computer system is a desktop computer, a laptop computer or preferably a notebook computer.

The host apparatus 10 includes a plurality of electronic elements including, for example, a mainboard 9, a hard disk drive 11, an optical drive 12, a camera 13, a memory 14, a central processing unit 15, a modem 16, a network connection port 17, a wireless signal receiving port 18 and a universal serial bus (USB) connection port 19.

The display 20 is electrically connected to the host apparatus 10. The boot mode switching unit 30 is electrically connected to the host apparatus 10, and may be switched between a first mode and a second mode. In the first mode, the boot mode switching unit 30 controls the host apparatus 10 to boot into a first operation environment. In the second mode, the boot mode switching unit 30 controls the host apparatus 10 to boot into a second operation environment different from the first operation environment.

In one example, all the electronic elements are enabled in the first operation environment, and the electronic elements are partially disabled in the second operation environment. In another example, all the electronic elements are enabled in the first and second operation environments. For example, all the mainboard 9, the hard disk drive 11, the memory 14 and the central processing unit 15 may be enabled in different operation environments. When a film stored in an optical disk has to be played, only the optical drive 12 is enabled. When a network conference is to be raised, only the camera 13 and the network connection port 17 are enabled. When a document is to be faxed, only the modem 16 is enabled. When the TV program is to be played, only the wireless signal receiving port 18 is enabled to receive the television program signal. When the digital photographs have to be displayed, only the USB connection port 19 is enabled, and the user can connect a mobile disk to the USB connection port 19.

Different operation environments may have different operation systems. For example, the first operation environment may be built in the Windows XP or Windows 2000 operation system, and the second operation environment may be built in Unix operation system or other dedicated operation systems. The number of software programs installed in the first operation environment is greater than the number of software program/programs installed in the second operation environment. The software program or one of the programs installed in the second operation environment is for playing a media file on the display 20 in conjunction with the host apparatus 10. The media file is stored in the hard disk drive 11 of the host apparatus 10, the optical disk in the optical drive 12, an external storage device or a remote apparatus.

Alternatively, the software program installed in the second operation environment is for displaying a digital photograph file on the display 20 in conjunction with the host apparatus 10. Alternatively, the software program of the second operation environment is for playing a digital television program or an analog television program on the display 20 in conjunction with the host apparatus 10.

Different operation environments may also have the same operation system. In order to build different operation environments in the same operation system, the number of software programs installed in the first operation environment is greater than the number of software program/programs installed in the second operation environment. In addition, the software program or one of the software programs installed in the second operation environment is for playing the media file, the digital photograph file, the digital television program or the analog television program on the display 20 in conjunction with the host apparatus 10, as mentioned hereinabove.

For example, the second operation environment is only installed with a media player, a photograph viewer or a television program player, and the other inessential daemon programs or drivers may be disabled in order to prevent the memory from being improperly occupied.

In brief, the second operation environment is dedicated to playing a media file, which is stored in an optical disk placed in an optical drive of the host apparatus 10, on the display 20. Consequently, the multi-function computer system may further include a set of playing function control buttons, which is electrically connected to the host apparatus 10, for controlling a play mode of the media file.

In order to prevent the user, who is not familiar with the computer operation, from unintentionally damaging the files stored in the hard disk drive under the second operation environment dedicated to playing the media file, it is possible to partition the hard disk drive of the host apparatus 10 into a first primary partition, which is hidden in the second operation environment, and a second primary partition, which is hidden in the first operation environment. In addition, the hard disk drive of the host apparatus 10 further has an extended partition, which is disabled in the second operation environment and enabled in the first operation environment.

In addition, the boot mode switching unit 30 may further be switched into a third mode, in which the boot mode switching unit 30 controls the host apparatus 10 to boot into a third operation environment different from the first operation environment and the second operation environment.

In practice, the boot mode switching unit 30 includes a plurality of switches or a multi-stage switch, which is disposed on a panel of the host apparatus 10 to provide the function of selecting the operation environment. Alternatively, the boot mode switching unit may be constituted by a remote controller and a receiver to have the function of remote control. The boot mode switching unit 30 is preferably, without limitation to, the key on the keyboard or the mouse, which is originally used in the computer system. However, the boot mode switching unit 30 may also be an additional switch disposed on the keyboard or the mouse, or a combination of several keys on the keyboard and/or the mouse.

According to the multi-function computer system of the invention, the user can selectively enter the dedicated operation environment according to the requirement to perform the dedicated work, and the invention can also prevent the user, which is not familiar with the computer, from unintentionally deleting the important files. In addition, using the hardware switch to directly control the specific operation of the dedicated operation system can help the user to operate the multi-function computer system conveniently.

While the invention has been described by way of example and in terms of a preferred embodiment, it is to be understood that the invention is not limited thereto. To the contrary, it is intended to cover various modifications. Therefore, the scope of the appended claims should be accorded the broadest interpretation so as to encompass all such modifications.

What is claimed is:

1. A multi-function computer system, comprising:
a host apparatus;
a display electrically connected to the host apparatus; and
a boot mode switching unit, which is electrically connected to the host apparatus and may be switched between a first mode and a second mode, wherein:
in the first mode, the boot mode switching unit controls the host apparatus to boot into a first operation environment; and
in the second mode, the boot mode switching unit controls the host apparatus to boot into a second operation environment different from the first operation environment.

2. The multi-function computer system according to claim 1, wherein the host apparatus comprises a plurality of electronic elements, all of the electronic elements are enabled in the first operation environment, and the electronic elements are partially disabled in the second operation environment.

3. The multi-function computer system according to claim 1, wherein the first operation environment and the second operation environment have different operation systems.

4. The multi-function computer system according to claim 3, wherein the number of software programs installed in the first operation environment is greater than the number of software programs or software program installed in the second operation environment.

5. The multi-function computer system according to claim 4, wherein the software program or one of the programs installed in the second operation environment is for playing a media file on the display in conjunction with the host apparatus.

6. The multi-function computer system according to claim 5, wherein the media file is stored in a hard disk drive of the host apparatus, an optical disk, an external storage device or a remote apparatus.

7. The multi-function computer system according to claim 4, wherein the software program or one of the programs installed in the second operation environment is for displaying a digital photograph file on the display in conjunction with the host apparatus.

8. The multi-function computer system according to claim 4, wherein the software program or one of the programs installed in the second operation environment is for playing a digital television program or an analog television program on the display in conjunction with the host apparatus.

9. The multi-function computer system according to claim 1, wherein the first operation environment and the second operation environment have the same operation system.

10. The multi-function computer system according to claim 9, wherein the number of software programs installed in the first operation environment is greater than the number of software programs or software program installed in the second operation environment.

11. The multi-function computer system according to claim 10, wherein the software program or one of the programs installed in the second operation environment is for playing a media file on the display in conjunction with the host apparatus.

12. The multi-function computer system according to claim 11, wherein the media file is stored in a hard disk drive of the host apparatus, an optical disk, an external storage device or a remote apparatus.

13. The multi-function computer system according to claim 10, wherein the software program or one of the programs installed in the second operation environment is for displaying a digital photograph file on the display in conjunction with the host apparatus.

14. The multi-function computer system according to claim 10, wherein the software program or one of the programs installed in the second operation environment is for playing a digital television program or an analog television program on the display in conjunction with the host apparatus.

15. The multi-function computer system according to claim 1, wherein the host apparatus has a hard disk drive, which has a first primary partition hidden in the second operation environment, and a second primary partition hidden in the first operation environment.

16. The multi-function computer system according to claim 15, wherein the hard disk drive further has an extended partition, which is disabled in the second operation environment and is enabled in the first operation environment.

17. The multi-function computer system according to claim 1, wherein the second operation environment is dedicated to playing a media file, which is stored in an optical disk placed in an optical drive of the host apparatus, on the display.

18. The multi-function computer system according to claim 17, further comprising:
a set of playing function control buttons, electrically connected to the host apparatus, for controlling a play mode of the media file.

19. The multi-function computer system according to claim 17, wherein the boot mode switching unit may further be switched into a third mode, in which the boot mode switching unit controls the host apparatus to boot into a third operation environment different from the first operation environment and the second operation environment.

20. The multi-function computer system according to claim 17, wherein the boot mode switching unit comprises a plurality of switches or a multi-stage switch disposed on a panel of the host apparatus.

21. The multi-function computer system according to claim 17, wherein the boot mode switching unit is constituted by a remote controller and a receiver.
